(19) United States
(12) Patent Application Publication
(10) Pub. No.: US 2007/0063528 A1
(43) Pub. Date: Mar. 22, 2007

(54) Vehicle sun visor

(76) Inventor: Hiroto Ogawa, Toyota-shi, Aichi-ken (JP)

Correspondence Address: CONLEY ROSE, P.C., P. O. BOX 3267, HOUSTON, TX, 77253-3267, US

(21) Appl. No.: 10/595,683

(22) PCT Filed: Nov. 4, 2004
(86) PCT No.: PCT/JP04/16320

§ 371 Date: May 4, 2006

(30) Foreign Application Priority Data
Nov. 5, 2003 (JP) 2003-376243

(51) Int. Cl. B60J 3/00

(52) U.S. Cl. 296/97.5

(57) ABSTRACT

A vehicle sun visor is provided enabling an illuminating device for a mirror to also be used for an illuminating device for a cardholder and a small article receptacle of a sun visor body. According to the present invention, a vehicle sun visor including a mirror (26) with a cover mounted to a surface of a sun visor body (20) and configured such that an illuminating device (40) hidden by the cover (30) is uncovered and illuminated when the cover is opened. The vehicle sun visor also includes an auxiliary lighting means that can light the illuminating device in the state where the cover is closed, and a light leaking means that can leak the light of the illuminating device to the outside of the cover such that the illuminating device can illuminate the surface of the sun visor body in the state where the cover is closed.

### FIELD OF THE INVENTION

This application relates to vehicle sun visors having a mirror with a cover and configured such that an illuminating device, hidden behind the cover, is uncovered and illuminated when the cover is opened.

### BACKGROUND ART

A relevant conventional vehicle sun visor is described in Patent Document 1.

The above vehicle sun visor has a sun visor body for shielding sunlight incident into a vehicle cabin. As shown in FIG. 6, a rectangular holder 94 is mounted to the center of a surface of the sun visor body. A mirror 95 and an illuminating device 96 are fixedly stored within the holder 94. A rotary cover 94h is mounted to the holder 94 so that the mirror 95 and the illuminating device 96 are uncovered, in the state where the rotary cover 94h is opened. A switch (not shown) is mounted to a rotational center portion of the rotary cover 94h and is configured so that the switch is turned on when the rotary cover 94h is opened, and the switch is turned off when the rotary cover 94h is closed. Turning on the switch may supply electric power to the illuminating device 96 and then the illuminating device 96 is illuminated. Thus, when the mirror 95 is used, via the opening of the rotary cover 95, the illuminating device 96 is automatically illuminated. Therefore, it is possible to use the mirror 95 even in the case in which the cabin is dark.

Patent Document 1: Japanese Laid-Open Patent Publication No. 2002-331834

### DISCLOSURE OF THE INVENTION

### Problems to be Solved by the Invention

According to the vehicle sun visor described above, when the mirror 95 is not used, or when the rotary cover 94h is closed, the illuminating device 96 is not illuminated because the switch is turned off. Therefore, it is not possible to use the illuminating device 96 for other purposes than illumination during the use of the mirror. For every time that it is desired to use the illuminating device 96 for any other purposes, it is necessary to open the rotary cover 94h. Therefore, the convenience in use is not good. The present invention has been made for solving the above problem. It is a technical object of the present invention to improve the versatility of a vehicle sun visor by enabling the use of an illuminating device of a mirror for other purposes while the cover of the minor is closed.

### Means for Solving the Problems

The above problem can be solved by the inventions defined in claims.

The invention according to claim 1 is a vehicle sun visor having a mirror with a cover mounted to a surface of a sun visor body and configured such that an illuminating device, hidden by the cover, is uncovered and illuminated when the cover is opened. The invention is characterized in that the vehicle sun visor includes an auxiliary lighting means that can illuminate the illuminating device in the state in which the cover is closed. A light-leaking means that can leak the light of the illuminating device to the outside of the cover such that the illuminating device can illuminate the surface of the sun visor body, in the state in which the cover is closed.

According to this invention, it is possible to light the illuminating device for the mirror by the auxiliary lighting means even in the event that the mirror is not used, or the cover of the mirror is closed At that time, the light from the illuminating device may be leaked to the outside of the cover by the operation of the light-leaking means and may illuminate the surface of the sun visor body. Therefore, the illumination device for the mirror can also be used as an illuminating device, such as, for a cardholder and a small article receptacle of the sun visor body.

The invention of claim 2 is characterized in that the auxiliary lighting means includes a rotary switch operating when the sun visor body has been pivoted from a storage position along a ceiling of a vehicle and a light-shielding position on the side of a window glass of the vehicle. A timer circuit is configured to be able to supply electric power to the illuminating device within a predetermined time period after the point when the rotary switch has operated. Here, the switch may include any type of construction that can electrically connect one electrical conductor to another electrical conductor, and can release the connection.

According to this invention, the rotary switch may operate by lowering the sun visor body from the storage position to the light-shielding position, so that the illuminating device is automatically illuminated. Thus, it is possible to use the mirror-illuminating device as an illuminating device for a cardholder and a small article receptacle of the sun visor body by simply lower the sun visor body to the light-shielding position. In addition, after a predetermined period of time has passed the supply of electric power to the illuminating device is terminated by the operation of the timer circuit. Therefore, no operation is required for turning off the light.

According to the invention of claim 3, the light-leaking means is a slit formed in an end edge of the cover. Therefore, it is possible to manufacture the light-leaking means at a low cost. Here, the light-leaking means may be a clearance, which is formed between the cover and the sun visor body in the state where the cover is closed as defined in claim 4, or may be a slit, formed in the sun visor body in such a position that is not hidden by the cover, as defined in claim 5. Further, the light-leaking means may be a transparent part formed on the cover and/or the sun visor body as defined in claim 6.

### ADVANTAGES OF THE INVENTION

According to the present invention, the illumination device for the mirror can also be used as an illuminating device, such as, for a cardholder and a small article receptacle of the sun visor body with the cover of the mirror held closed. Therefore, the convenience can be improved in the use of the vehicle sun visor.

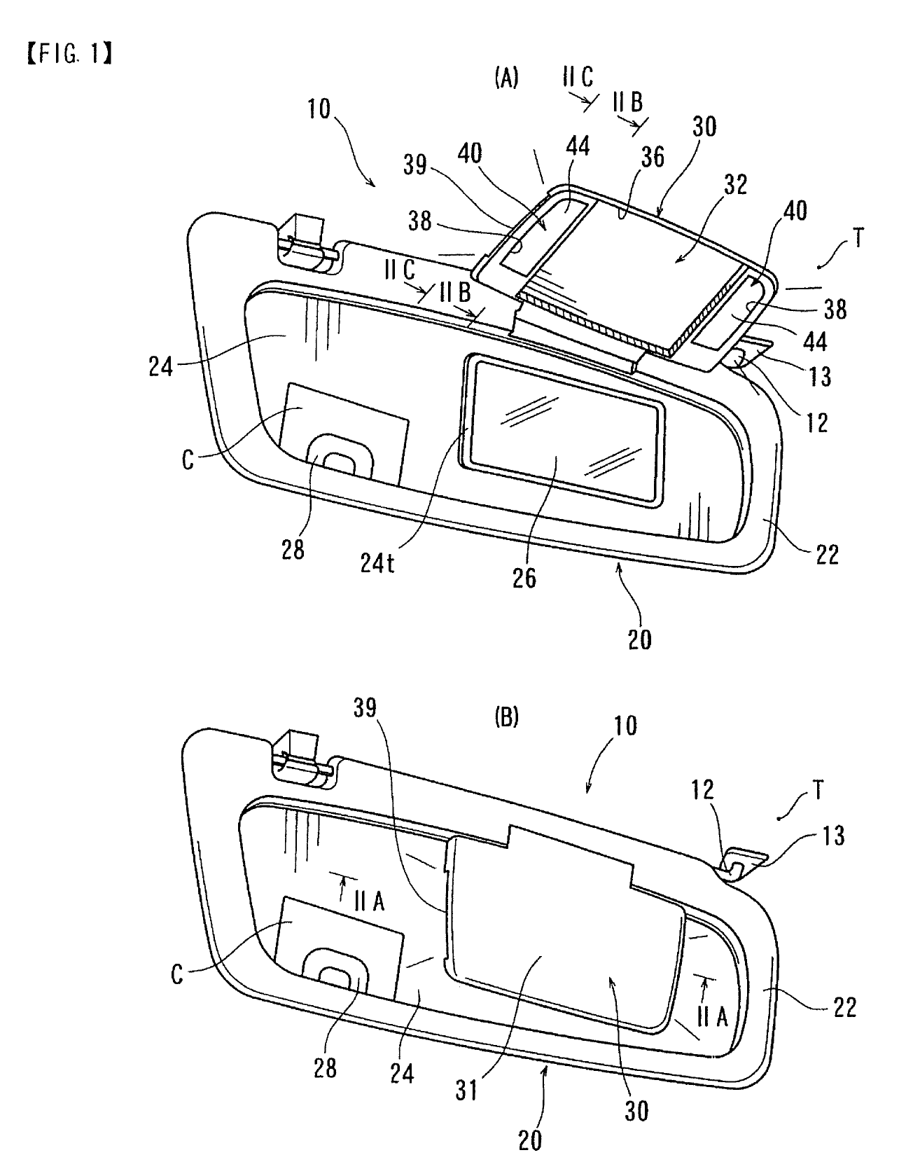

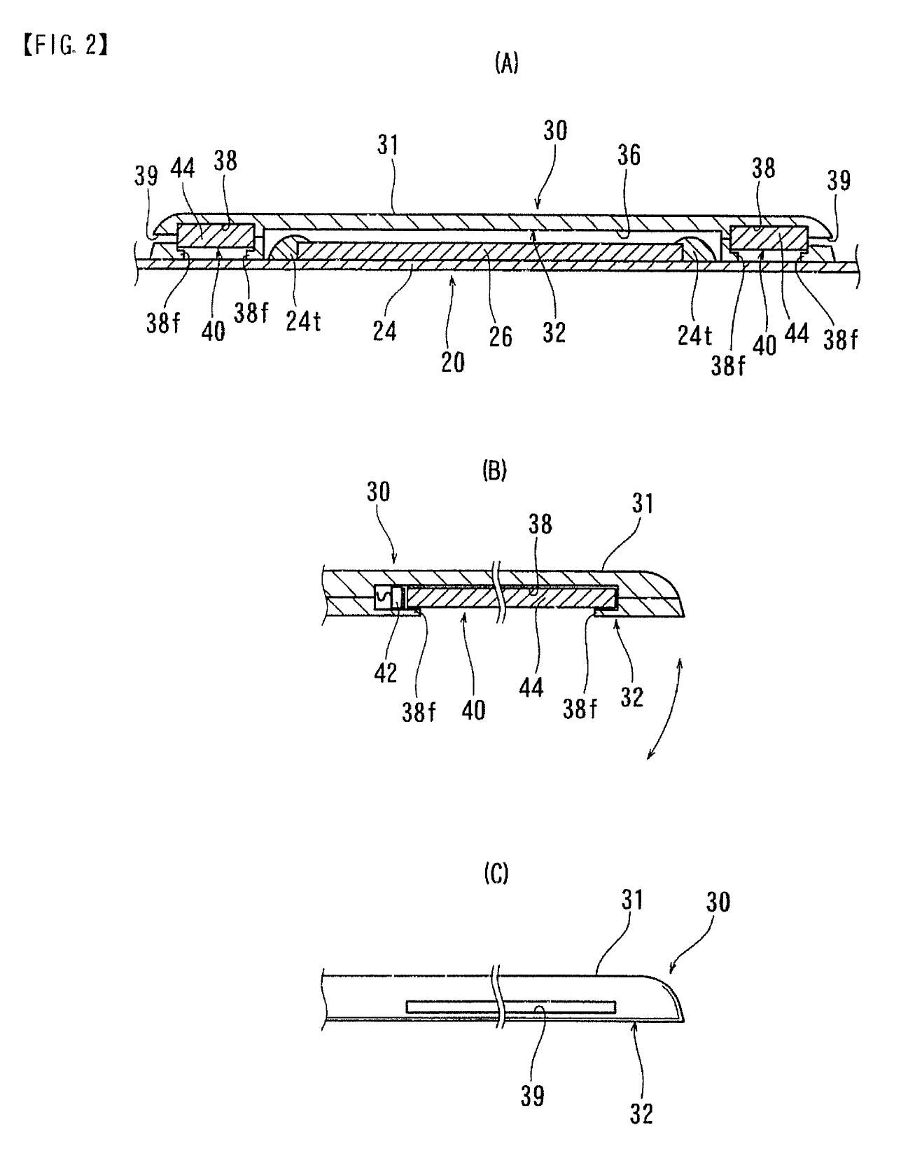

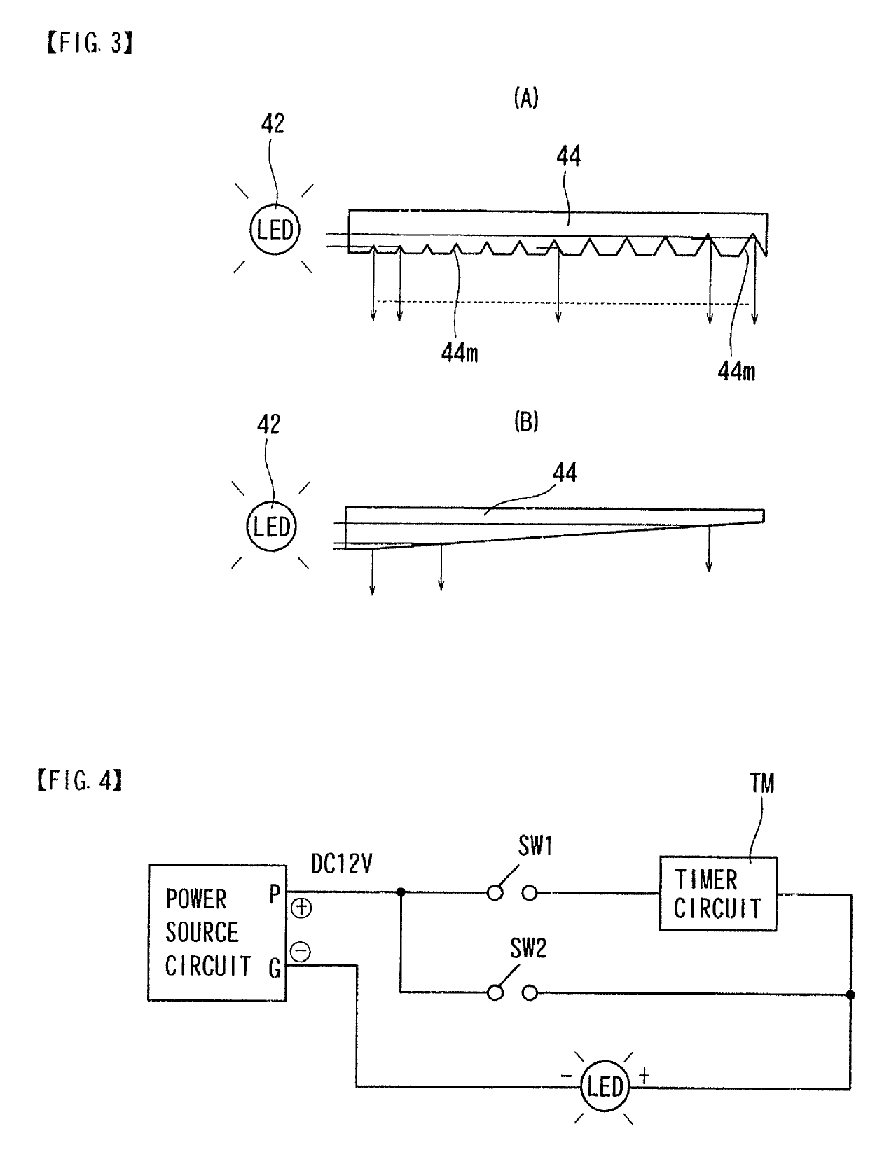

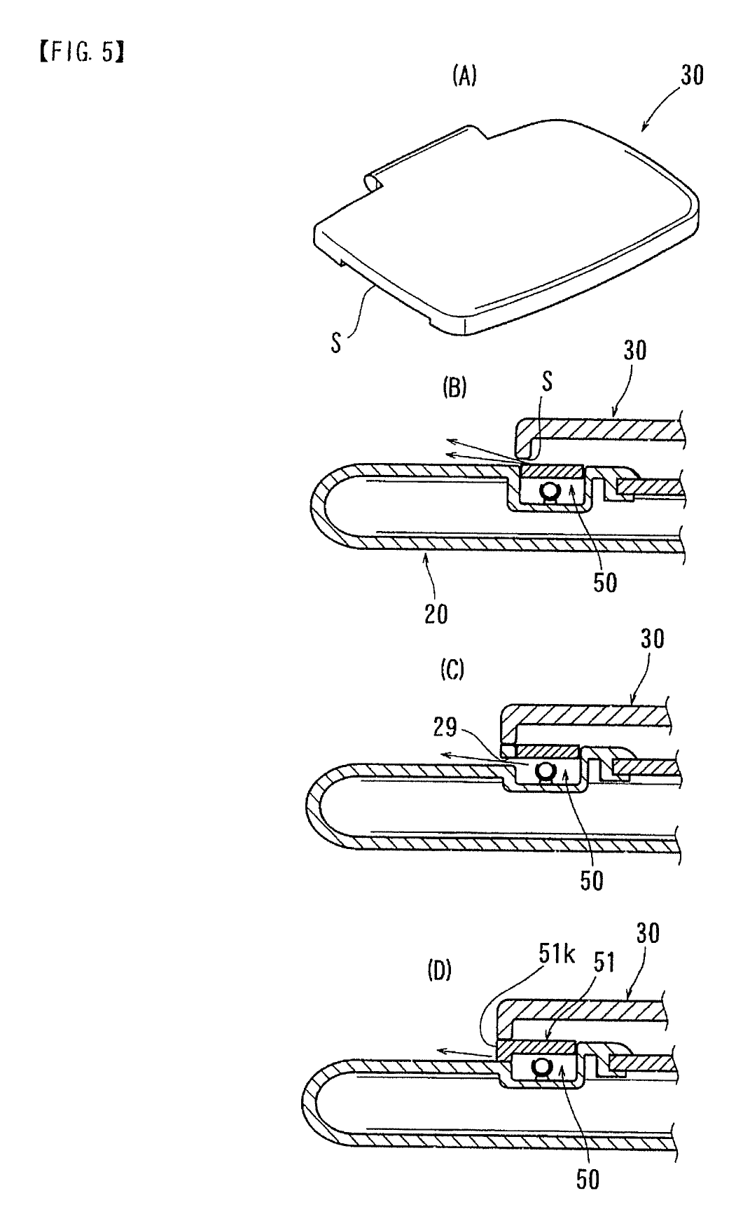

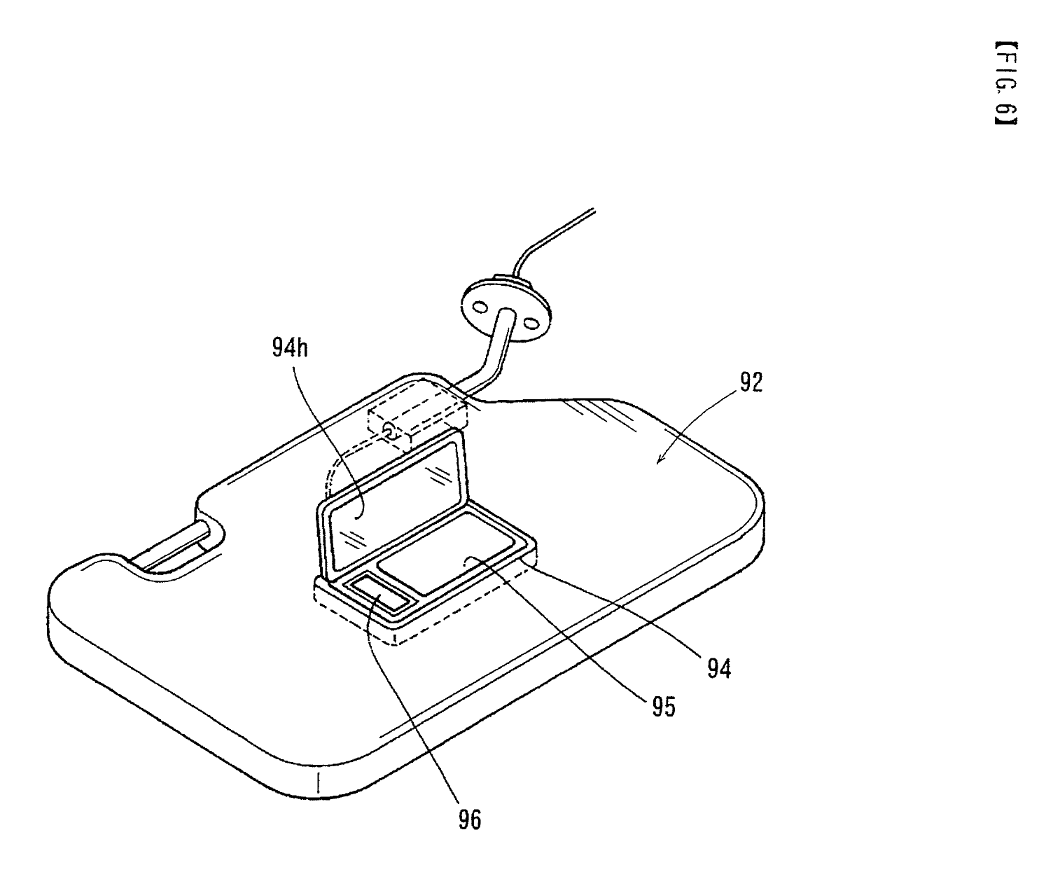

### BRIEF DESCRIPTION OF THE DRAWINGS

[FIG. 1] This is a perspective view of the entire vehicle sun visor (in the state in which a cover is opened) according to a first embodiment of the present invention (view A), and a perspective view of the entire vehicle sun visor (in the state in which the cover is closed) (view B).

[FIG 2] This is a vertical sectional view showing a part of a mirror and a cover of the vehicle sun visor (taken along line IIA-IIA in FIG. 1(B)) (view A), a cross-sectional view taken along line IIB-IIB in FIG. 1(A) (view B), and a cross-sectional view taken along line IIC-IIC in FIG. 1(A) (view C).

[FIG. 3] This is a schematic view showing the construction of an illuminating device (views A and B).

[FIG. 4] This is an electrical circuit configuration of the illuminating device.

[FIG. 5] This is an enlarged partial view showing modifications of the vehicle sun visor (views A, B, C, and D)

[FIG. 6] This is a perspective view of a vehicle sun visor according to a prior art.

Description of Numerals

| | |
|---|---|
| 10 | sun visor body |
| 26 | mirror |
| 30 | cover |
| 39 | slit (light-leaking means) |
| 40 | illuminating device |
| 42 | LED |
| 44 | light guide panel |
| SW1 | rotary switch of the sun visor body (auxiliary lighting means) |
| TM | timer circuit (auxiliary lighting means) |

Best Mode for Carrying out the Invention

### FIRST EMBODIMENT

A vehicle sun visor according to a first embodiment will now be described based upon FIGS. 1 to 5. Here, FIG. 1 is a perspective view of the entire vehicle sun visor according to this embodiment, and FIG. 2 is a vertical cross-sectional view, etc., showing a portion of a mirror and a cover of the vehicle sun visor. FIG. 3 is schematic views showing the arrangement of an illuminating device, and FIG. 4 is an electrical circuit configuration of the illuminating device. Further, FIG. 5 is a partly enlarged view, etc., showing a modification of the vehicle sun visor.

As shown in FIG. 1, a vehicle sun visor 10 has a sun visor body 20 for shielding sunlight incident into a vehicle cabin, and a support rod 12 that vertically rotatably supports the sun visor body 20. A base end of the support rod 12 is joined to a support flange 13, which is secured to a vehicle cabin-ceiling surface T. With this construction, the sun visor, body 20 can vertically pivot between a storage position, along the vehicle cabin-ceiling surface T, and a light-shielding position, along the side of a window glass. FIG. 1 (A)(B) shows a state in which the sun visor body 20 has been lowered to the light-shielding position.

A peripheral portion 22, formed to have a thick thickness, and a plate-like portion 24, disposed inside of the peripheral portion 22 and having a relatively thin thickness, constitute the sun visor body 20. On the surface on the side opposing to a passenger when the sun visor body 20 is in the light-shielding position, or a surface of the sun visor, body 20, a rectangular mirror 26 is mounted at a substantially central position of the plate-like portion 24. The mirror 26 is secured to the plate-like portion 24 and held by trim 24t, which has an end edge integrated with the plate-like portion 24 and has a hook-like cross-section. A cardholder 28 is disposed on the lower left portion of the surface of the sun visor body 20, for holding a card C at a boundary part between the peripheral portion 22 and the plate-like portion 24.

A cover 30 of the mirror 26 is vertically pivotally joined to the surface of the sun visor body 20 at a position on the upper part of the peripheral portion 22. The cover 30 is configured to be able to vertically pivot between a closed position, in which the cover 30 is laid over the plate-like portion 24 of the sun visor body 20 and entirely covers the mirror, 25, as shown in FIG. 1(B) and FIG. 2(A), and an opened position, in which the cover 30 uncovers the mirror 26 as shown in FIG. 1(A). When in the opened position, the cover 30 is held substantially perpendicular to the sun visor body 20 by the resilient force of a spring or the like (not shown).

The thickness of the cover 30 is set to have such a value that the level of a surface 31 of the cover 30 is substantially the same as the level of the peripheral portion 22 of the sun visor body 20, when the cover 30 has been laid over the plate-like portion 24 of the sun visor body 20.

In a surface 32 or an inner surface 32 of the cover 30, opposite to the surface 31, a mirror recess 36 is formed for storing the mirror 26 when the cover 30 is in the closed position, as shown in FIG. 2(A). Here, FIG. 2(A) shows a cross-sectional view taken along line IIA-IIA in FIG. 1(B). In addition, illumination device recesses 38 are formed in the inner surface 32 of the cover 30 for storing illumination devices 40 (that will be explained later) on opposite sides of the mirror recess 36 in the widthwise direction.

The illuminating devices 40 are those commonly used for illuminating the mirror 26 and for illuminating the cardholder 28. The illuminating devices 40 are respectively configured by light emitting diodes 42 (hereinafter called LEDs 42) as light sources, and light guide panels 44 for directing the light from the LEDs to predetermined positions, and for substantially uniformly refracting and scattering the lights.

The light guide panels 44 are rectangular transparent panels that are stored within the respective illuminating device recesses 38. Inner flanges 38f, formed on open edges of the respective illuminating device recesses 38, hold the peripheral portions of the light guide panels 44. The LEDs 42 are stored within the illuminating device recesses 38 at positions nearest to the pivotal center of the cover 30 and are located inside of the inner flanges 38f, as shown in FIG. 2(B). Although in general, two LED's 42 are used for one light guide panel 44, the number to be used can be suitably changed. FIG. 2(B) is a cross-sectional view taken along line IIB-IIB in FIG. 1(A).

FIG. 3(A)(B) are schematic views showing the operation of the light guide panel 44 of the above illuminating device 40.

As shown in FIG. 3(A), a plurality of grooves 44m, having V-shaped cross-sections, is formed on the surface of a light guide panel 44 for refracting the light, which travels along the light guide panel 44, to directions intersecting with the traveling directions. The grooves 44m have depths and widths that become greater as the distance from the LED 42 becomes larger. Here, the amount of light (refracted light) is proportional to the groove area of the groove 44m. Therefore, the amount refracted light increases as the depth and width of a groove 44m becomes greater. On the other hand, the light energy decreases in inverse proportion to the square of the distance from the LED 42. As a result, the light energy is greater at a position proximal to the LED 42 and is smaller at a position remote from the LED 42.

In the illuminating device 40, the depths and widths of the grooves 44m are determined such that the amount of the refracted light is substantially uniform over the entire light guide panel 44, taking into account the decrease in the energy at the respective grooves 44m. Acryl, polycarbonate, etc., may be preferably used as the material of the light guide panels 44. Instead of forming the grooves 44m as described above, the surface of the light guide panel 44 may be configured as an inclined surface with fine irregularities, as shown in FIG. 3(B), so that the inclined surface may refract the light.

As described above, the light guide panels 44 are stored within the illumination device recesses 38, formed in the inside surface 32 of the cover 30, and are held by the inner flanges 38f, formed on the open edges of the illumination device recesses 38. Therefore, when the cover 30 is in an opened state, the light from the LEDs 42 may be substantially uniformly radiated from the openings of the illumination device recesses 38 to illuminate the surroundings.

Further, as shown in FIG. 2(C), slits 39 are formed for communicating with the inner spaces of the illumination device recesses 38 in opposite side surfaces in the widthwise direction of the cover 30 and along the lengthwise direction of the cover 30. Even if the cover 30 is in a closed state, the slits 39 may leak the light from the LEDs 42, which was refracted by the light guide panels 44, to the outside in order to enable illumination of the surface of the sun visor body 20. Thus, the slits 39 may correspond to a light-leaking device according to the present invention. Here, FIG. 2(C) shows a view as viewed from line IIC-IIC in FIG. 1(A). Preferably, reflecting panels (not shown) may be attached to the wall surfaces of the illumination device recesses 38.

FIG. 4 shows an electrical circuit configuration of the illuminating device 40

The DC 12V battery power source of the vehicle may be used as a power source of the electrical circuit. As shown in the figure, a +12V terminal P is connected to the plus terminal of the LED 42 via a rotary switch SW1 of the sun visor body 20 and a timer circuit TM. A rotary switch SW2 of the covert 30 is connected in parallel to the rotary switch SW1 of the sun visor body 20 and the timer circuit TM. A minus terminal of the LED 42 is connected to an earth terminal G of the power source circuit.

Therefore, when the rotary switch SW1 of the sun visor body 20 is turned on, the LED 42 is illuminated for a period of time (egg 10 seconds) determined by the timer circuit TM. Even after the period of time determined by the timer circuit TM has been passed, the LED 42 may be illuminated during the time that the rotary switch SW2 of the cover 30 is turned on. Here, the rotary switch SW1 of the sun visor body 20 is configured such that the switch is turned on when the sun visor body 20 is in the lowered state at the light-shielding position, while the switch is turned off when the sun visor body 20 is midway in an upward movement toward the storage position. The rotary switch SW2 is turned on when the cover 30 is held in the opened position, while it is turned off midway in the returning movement of the cover 30 to the closed position

The operation of the vehicle sun visor 10 according to this embodiment will now be described, For example, if a highway card C is to be taken out from the cardholder 28 of the sun visor body 20 during nighttime traveling of the vehicle, the sun visor body 20 may be lowered from the storage position to a light-shielding position This may turn on the rotary switch SW1 of the sun visor body 20, so that the LEDs 42 of each illuminating device 40 are illuminated during a time period (e.g. 10 seconds) determined by the timer circuit TM. When an LED 42 is illuminated, the light from the LED 42 may travel along the light guide panel 44 and may be refracted by each of the grooves 44m of the light guide panel 44. The light guide panel 44 may shine substantially uniformly because the grooves 44m are configured such that the amount of refracted light is substantially uniform across the light guide panel 44, irrespective of the distance from the LED 42. The light refracted by the light guide panel 44 may leak to the outside via the corresponding slits 39 of the cover 30 so as to illuminate the surroundings, since the cover 30 is in a closed position in this state. Therefore, the surroundings of the cardholder 28 are illuminated so that the driver can easily take out the highway card C.

An operation for turning off the illuminating device 40 is not necessary because the LED 42 of the illuminating device 40 is turned off after 10 seconds by the timer circuit TM. Therefore, a problem, such as leaving without turning off, may be avoided. Although the LED 42 may be illuminated when the sun visor body 20 has been lowered to a light-shielding position in order to shield sunlight, no particular problems may be caused because the timer circuit TM automatically turns off the LED 42 after 10 seconds. Consequently, the rotary switch SW1 and the timer circuit TM of the sun visor body 20 in the electric circuit may correspond to an auxiliary lighting means according to the present invention.

Further, when a passenger uses the mirror 26 of the sun visor body 20 during nighttime, the sun visor body 20 may be lowered from the storage position to the light-shielding position. As described above, this may turn on the LED 42 of the illuminating device 40, and the light may be leaked from the corresponding slit 39 of the cover 30 to the outside, so that the location of the cover 30 can be clearly recognized. In this state, opening the cover 30 may turn on the rotary switch SW2 of the cover 30. Therefore, the LED 42 of the illuminating device 40 may remain illuminated even after the time period determined by the timer circuit TM has been passed. As the cover 30 is opened, the opening of the illuminating device recess 38, formed in the inner surface 32 of the cover 30, is uncovered, so that the light of the LED 42 may be substantially uniformly radiated and scattered from the surface (exposed surface) of the light guide panel 44, and may illuminate the passenger's face from the circumference of the mirror 26. As a result, it is possible to use the mirror 26 even during the nighttime. At that time, the passenger is not required to directly look at the light guide panel 44 in order to see the mirror 26. Thus, he or she may not feel dazzled. When the cover 30 is closed, the rotary switch SW2 may be turned off so that the LED 42 of the illuminating device 40 is turned off.

As described above, according to the vehicle sun visor 10 of this embodiment, even if the cover 30 of the mirror 26 is closed, the lighting devices 40 may be turned on by the operation of the rotary switch SW1 of the sun visor body 20 and the timer circuit TM, as the auxiliary lighting means. At that time, the light from the illuminating devices 40 may be leaked to the outside by the operation of the slits 39 as the light-leaking device and may illuminate the surface of the sun visor body 20. Therefore, it is possible to use the mirror illumination devices 40 also as illuminating devices for the cardholder 28, etc., of the sun visor body 20. If a small article receptacle and other tools are mounted to the surface of the sun visor body 20, it is possible to also illuminate the small article receptacle, etc.

When the sun visor body 20 is lowered from a storage position to the light-shielding position, the rotary switch SW1 is operated to automatically turn on the illuminating devices. In addition, due to the operation of the timer circuit TM, a supply of power to the illuminating devices 40 may be terminated after passing a predetermined time period (e.g. 10 seconds). Therefore, no operation for turning on or off the light is necessary, and a problem of leaving without turning off may be avoided so that the convenience in use may be improved. Further, because the light-leaking device is slits 39 formed in the end edges of the cover 30, the light-leaking device can be manufactured at a low cost.

Furthermore, although the illuminating devices 40 are mounted to the cover 30, and the slits 39 as the light leaking means are formed in the cover 30 in this embodiment, illuminating devices 50 may be mounted to the sun visor body 20 as shown in FIG. 5(B), and clearances S between the sun visor body 20 and the cover 30 may be used as a light leaking means (see FIG. 5(A)(B)). Alternatively, the illuminating devices 50 may be mounted to the sun visor body 20 as shown in FIG. 5(C), and slits 29 as a light leaking means may be formed in positions of the sun visor body 20 where the slits are not hidden by the cover 30. In addition, it is possible to fit a lens into a part of the slit 29 or 39, or it is possible to fit a lens into the entire slit 29 or 39. With this arrangement, it is possible to extend the light reaching distance.

Furthermore, in place of forming the slits 29, 39, it is possible to form parts of the cover 30 or the sun visor body 20 to be transparent. For example, as shown in FIG. 5(D), a transparent cover 51 for the illuminating device 50 may be configured to have an L-shape configuration in cross-section. A vertical wall portion 51k of the transparent cover 51 may be positioned between the cover 30 and the sun visor body 20 when the cover 30 has been closed. Preferably, the transparent cover 51 is a lens.

Furthermore, the illuminating device 50 having an electric bulb as a light source is shown in FIG. 5(B)(C)(D). It is possible to use the illuminating device 40 having the LED 42 and the light guide panel 44.

The vehicle sun visor 10 according to the embodiment utilizing the LED 42 and the light guide panel 44 as the illuminating device 40 may enable forming the illuminating device 40 to have a thin and compact construction in comparison with the case in which an electric bulb, etc. is used as an illuminating device. Therefore, it is possible to mount the illuminating device 40 to the cover 30 for the mirror 26, etc., so that freedom in mounting the illuminating device 40 is improved.

The inventions disclosed in the embodiment but are not defined in the claims are listed below:
(1) A vehicle sun visor having a mirror with a cover mounted to a surface of a sun visor body and configured such that an illuminating device hidden by the cover is uncovered and illuminated when the cover is opened, characterized in that the illuminating device is mounted to the cover. As a result, when the user sees the mirror, it is not necessary to directly look at the illuminating device. Thus, he or she may not feel dazzled.
(2) The vehicle sun visor as defined in (1), characterized in that:
   the illuminating device has a light emitter comprising an LED, and a light guide panel that directs and refracts the light emitted from the light emitter; and
   the light guide panel is mounted to an inner surface of the cover in parallel thereto and refracts the light emitted from the light emitter in a direction opposite to the cover after guiding the light along the inner surface of the cover.

Because the LED is used as a light emitter, the size of the illuminating device can be reduced in comparison with the case where an electric bulb is used. In addition, it is possible to manufacture the cover to have a compact size even with the illuminating device mounted to the cover. In addition, because the light guide panel is incorporated, it is possible to guide the light of the LED to a desired position, and therefore, it is possible to effectively use the light from the LED for the purpose of illumination.
(3) The vehicle sun visor as defined in (2), characterized in that:
   the light guide panel is configured such that a larger amount of light is refracted as the distance from the light emitter increases.

Therefore, it is possible to substantially uniformly refract and scatter the light from the panel surface of light guide panel.
(4) The vehicle sun visor as defined in (1) to (3), characterized in that:
   the illuminating device is disposed on either side of the cover in the widthwise direction.

Therefore, either side of the sun visor body in the widthwise direction can be illuminated with substantially the same brightness.

1-6. (canceled)

7. A vehicle sun visor comprising a mirror with a cover mounted to a surface of a sun visor body and configured such that an illuminating device hidden by the cover is uncovered and illuminated when the cover is opened, wherein the vehicle sun visor further comprises:
an auxiliary lighting device that can light the illuminating device in the state where the cover is closed; and
a light leaking device that can leak the light of the illuminating device to the outside of the cover such that the illuminating device can illuminate the surface of the sun visor body in the state where the cover is closed.

8. The vehicle sun visor as in claim 7, wherein:
the auxiliary lighting device comprises:
a rotary switch operating when the sun visor body has been pivoted from a storage position along a ceiling of a vehicle and a light-shielding position on the side of a window glass of the vehicle; and
a timer circuit configured to be able to supply electric power to the illuminating device within a predetermined time period after the point when the rotary switch has been operated.

9. The vehicle sun visor as in claim 7, wherein:
the light leaking device comprises a slit formed in an end edge of the cover.

10. The vehicle sun visor as in claim 7, wherein:
the light leaking device comprises a clearance that is formed between the cover and the sun visor body in the state where the cover is closed.

11. The vehicle sun visor as in claim 7, wherein:
the light leaking device comprises a slit formed in the sun visor body in such a position that is not hidden by the cover.

12. The vehicle sun visor as in claim 7, wherein:
the light leaking means comprises a transparent part formed on the cover and/or the sun visor body.

13. A vehicle sun visor comprising a mirror with a cover mounted to a surface of a sun visor body and configured such that an illuminating device hidden by the cover is uncovered and illuminated when the cover is opened, wherein the illuminating device is mounted to the cover.

14. The vehicle sun visor as in claim 13, wherein:
the illuminating device has a light emitter comprising an LED, and a light guide panel that directs and refracts the light emitted from the light emitter; and
the light guide panel is mounted to an inner surface of the cover in parallel thereto and refracts the light emitted from the light emitter in a direction opposite to the cover after guiding the light along the inner surface of the cover.

15. The vehicle sun visor as in claim 14, wherein the light guide panel is configured such that a larger amount of light is refracted as the distance from the light emitter increases.

16. The vehicle sun visor as in claim 13, wherein the illuminating device is disposed on either side of the cover in the widthwise direction.
